(19) United States
(12) Patent Application Publication
(10) Pub. No.: US 2019/0265405 A1
(43) Pub. Date: Aug. 29, 2019

(54) ILLUMINATION DEVICE AND DISPLAY DEVICE

(71) Applicant: SHARP KABUSHIKI KAISHA, Sakai City (JP)

(72) Inventors: YUKI OKAWA, Sakai City (JP); KENTARO KAMADA, Sakai City (JP)

(21) Appl. No.: 16/279,714

(22) Filed: Feb. 19, 2019

(30) Foreign Application Priority Data
Feb. 23, 2018 (JP) 2018-030607

(51) Int. Cl. F21V 8/00

(52) U.S. Cl. CPC G02B 6/0083; G02B 6/0073; G02B 6/009; G02B 6/0065; G02B 6/0068

(57) ABSTRACT

An illumination device includes a first LED unit, a second LED unit which is arranged vertically above the first LED unit and whose power consumption is smaller than power consumption of the first unit, and a light guide plate having a first light incident surface which is composed of a surface facing the first unit and through which light emitted from the first unit enters, a second light incident surface which is composed of a surface facing the second LED unit and through which light emitted from the second unit enters, and a light emitting surface which is composed of one plate surface and from which light incident from the first light incident surface and the second light incident surface is emitted.

### BACKGROUND

### 1. Field

The present disclosure relates to an illumination device and a display device.

### 2. Description of the Related Art

As an illumination device, a device has been known in which light sources are respectively arranged on both upper and lower sides of a light guide plate (Japanese Unexamined Patent Application Publication No. 2014-92699).

In a configuration in which light sources are respectively arranged on both upper and lower sides of the light guide plate as in Japanese Unexamined Patent Application Publication No. 2014-92699, air warmed by heat generated from the first light source arranged on the lower side goes up, and the light source arranged on the upper side is warmed by the air. Therefore, there is concern that the light source arranged on the upper side becomes high temperature as compared with the light source arranged on the lower side. When the light source becomes high temperature, there is concern of deterioration of light emission efficiency and product life of the light source and melting of the light guide plate facing the light source.

When the light sources are respectively arranged on both upper and lower sides of the light guide plate, it is desirable to suppress a situation in which the light source arranged on the upper side becomes high temperature.

### SUMMARY

According to an aspect of the disclosure, there is provided an illumination device including a first light source, a second light source which is arranged vertically above the first light source and whose power consumption is smaller than power consumption of the first light source, and a light guide plate having a first light incident surface which is composed of a surface facing the first light source and through which light emitted from the first light source enters, a second light incident surface which is composed of a surface facing the second light source and through which light emitted from the second light source enters, and a light emitting surface which is composed of one plate surface and from which light incident from the first light incident surface and the second light incident surface is emitted.

### BRIEF DESCRIPTION OF THE DRAWINGS

FIG. 1 is an exploded perspective view showing an approximate configuration of a television receiver according to a first embodiment of the present disclosure;

FIG. 2 is an exploded perspective view showing an approximate configuration of a liquid crystal display device;

FIG. 3 is a cross-sectional view of the liquid crystal display device (corresponding to a view taken along line III-III in FIG. 1;

FIG. 4 is a block diagram showing an electrical configuration according to an LED substrate;

FIG. 5 is a plan view showing a backlight device; and

FIG. 6 is a plan view showing a backlight device according to a second embodiment.

### DESCRIPTION OF THE EMBODIMENTS

### First Embodiment

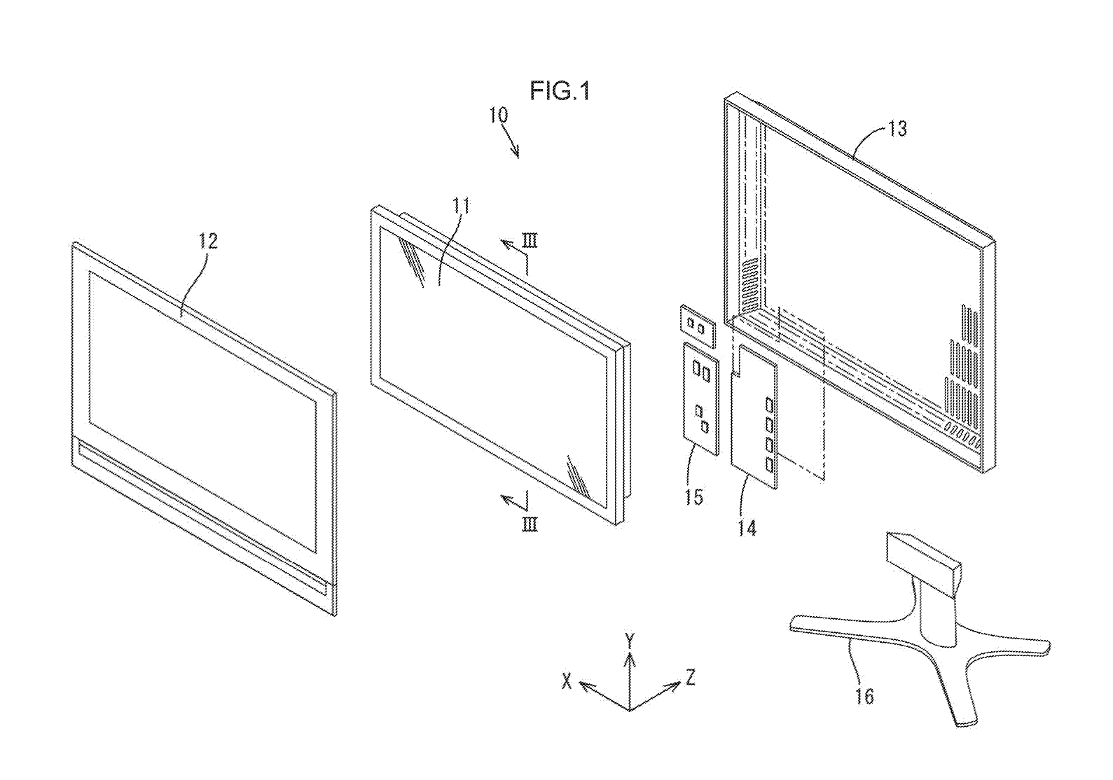

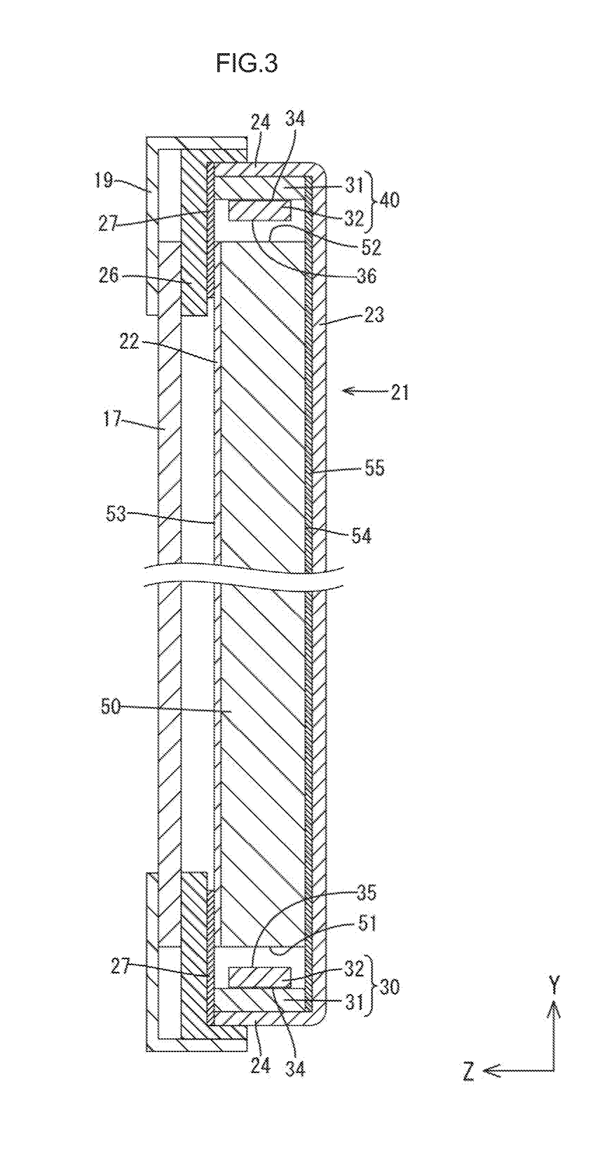

A first embodiment of the present disclosure will be described with reference to FIGS. 1 to 4. In the present embodiment, a liquid crystal display device 11 included in a television receiver 10 will be illustrated as a display device. Each drawing partially shows X, Y, and Z axes, and each drawing is drawn so that each axis direction is a direction shown in each drawing. A left side shown in FIG. 3 is a front side, and a right side shown in FIG. 3 is a back side. As shown in FIG. 1, the television receiver 10 includes the liquid crystal display device 11, cabinets 12 and 13 on both front and back sides which house the liquid crystal display device 11 so as to sandwich the liquid crystal display device 11, a power source 14, a tuner 15, and a stand 16. The liquid crystal display device 11 (display device) has a horizontally long square shape (a rectangular shape or a longitudinal shape) as a whole and is housed in a state of upright posture. In other words, the liquid crystal display device 11 is arranged in a standing posture whose short-side direction is along with a vertical direction. In the present embodiment, the Y axis direction corresponds to the vertical direction and the short-side direction of the liquid crystal display device 11.

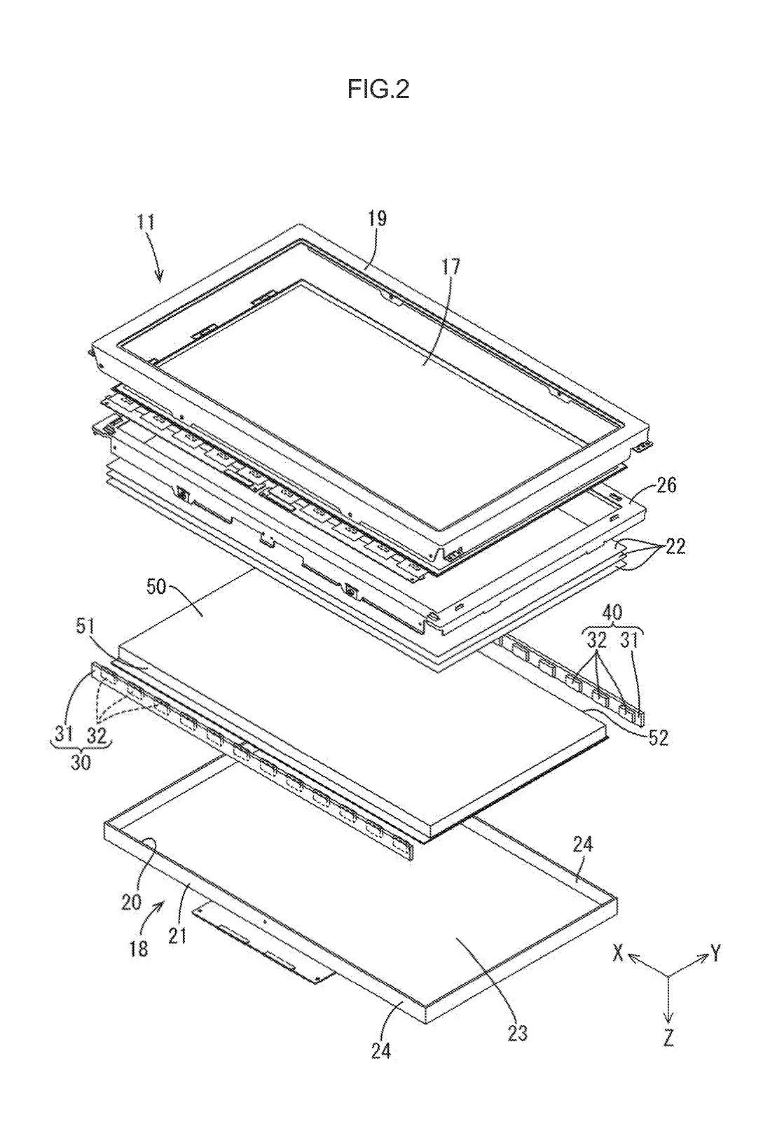

As shown in FIG. 2, the liquid crystal display device 11 includes a liquid crystal panel 17, which is a display panel, and a backlight device 18 (an illumination device), which is an external light source, and these are integrally held by a frame-shaped bezel 19. The liquid crystal panel 17 can display an image by using light emitted from the backlight device 18. As shown in FIG. 2, the liquid crystal panel 17 has a horizontally long square shape (a rectangular shape) and has a configuration in which a highly translucent pair of substrates (array substrate and CF substrate) made of glass are bonded together with a predetermined gap therebetween and a liquid crystal is sealed between both substrates. The array substrate is provided with switching elements (for example, TFTs) connected to source wirings and gate wirings that are perpendicular to each other, pixel electrodes connected to the switching elements, an oriented film, and the like. The CF substrate is provided with a color filter where colored portions such as R (red), G (green), and B (blue) are arranged in a predetermined arrangement, a counter electrode, an oriented film, and the like. The liquid crystal panel 17 is divided into a display area which is located around the center of a screen and can display an image, and a non-display area which is located in an outer circumferential end portion of the screen and forms a frame shape (picture frame-like shape) surrounding the display area. A pair of front and back polarizing plates are attached to outer surface sides of the pair of the substrates.

As shown in FIG. 2, the backlight device 18 includes a chassis 21 which has approximately a box shape and has a light emitting portion 20 opening toward a front side (toward a light emitting side or toward the liquid crystal panel 17), an optical member 22 arranged so as to cover the light emitting portion 20 of the chassis 21, a pair of LED units 30 and 40, a light guide plate 50 that guides light from the pair of LED units 30 and 40 to the optical member 22 (eventually to the liquid crystal panel 17), and a frame 26 (a pressing member) that presses the light guide plate 50 and the optical member 22 from the front side. Each of the LED units 30 and 40 includes an LED substrate 31 and a plurality of LEDs 32 (Light Emitting Diodes). The backlight device 18 is a so-called edge light type (side light type) backlight device, in which the LED units 30 and 40 are respectively arranged in both end portions on long sides of the backlight device 18, and the light guide plate 50 is sandwiched between the pair of LED units 30 and 40. Hereinafter, each component of the backlight device 18 will be described in detail.

The chassis 21 is composed of a metal plate such as, for example, an aluminum plate or an electrogalvanized steel plate (SECC). As shown in FIG. 2, in plan view, the chassis 21 has a horizontally long square shape and its short-side direction corresponds to the Y axis direction (vertical direction) in the same manner as the liquid crystal panel 17. The chassis 21 has a bottom plate 23 with a horizontally long square shape and side plates 24 respectively rising from long side outer edges and short side outer edges of the bottom plate 23. As shown in FIG. 3, the LED substrates 31 and 31 are respectively attached to a pair of side plates 24 and 24, which are arranged on the long sides, among the four side plates 24. The LED unit 40 (second light source) is arranged vertically above the LED unit 30 (first light source). The frame 26 and the bezel 19 are screwed to each side plate 24.

As shown in FIG. 2, the optical member 22 has a horizontally long square shape in plan view in the same manner as the liquid crystal panel 17. The optical member 22 is mounted on a front side (light emitting side) of the light guide plate 50, causes light emitted from the light guide plate 50 to pass through, and causes the passing light to be emitted to the liquid crystal panel 17 while giving a predetermined optical effect to the passing light. The optical member 22 is composed of a plurality of (in the present embodiment, three) sheet-shaped members laminated with each other. Examples of specific types of the optical member 22 (optical sheet) include a diffusion sheet, a lens sheet, a reflection type polarizing sheet, and the like. As the optical member 22, an appropriated one can be selected from among these and used. In FIG. 3, three optical members 22 are simplified into one optical member and shown.

As shown in FIG. 2, the frame 26 is formed into a frame shape (picture frame-like shape) extending along an outer circumferential end portion of the light guide plate 50. The frame 26 can press nearly the entire circumferential end portion of the light guide plate 50 from the front side. The frame 26 is made of, for example, synthetic resin, and its surface is black, so that the frame 26 has light-blocking properties. As shown in FIG. 3, on the frame 26, surfaces facing the LED units 30 and 40 are provided with light reflecting sheets 27, respectively. The light reflecting sheets 27 and 27 have a size extending over the entire length of the long side of the frame 26. One light reflecting sheet 27 covers the LED unit 30 and an end portion of the light guide plate 50 on the LED unit 30 side from the front side. The other light reflecting sheet 27 covers the LED unit 40 and an end portion of the light guide plate 50 on the LED unit 40 side from the front side. The frame 26 can receive an outer circumferential edge portion of the liquid crystal panel 17 from the back side.

Next, configurations of the LED units 30 and 40 will be described. The LED unit 30 and the LED unit 40 are the same components, but their mounting positions and mounting postures are different. In the present embodiment, the LED unit arranged on the vertically lower side is the LED unit 30 and the LED unit arranged on the vertically upper side is the LED unit 40. The number of LEDs 32 included in the LED unit 30 and the number of LEDs 32 included in the LED unit 40 are the same, and gaps between the plurality of LEDs 32 included in the LED unit 30 and gaps between the plurality of LEDs 32 included in the LED unit 40 are the same. The LED 32 has a configuration where an LED chip is sealed on a substrate portion fixed to the LED substrate 31 with a resin material. A main emission wavelength of the LED chip mounted on the substrate portion is one type. Specifically, the LED chip emits single color light of blue. On the other hand, a phosphor, which is excited by blue light emitted from the LED chip and emits light of a predetermined color, is dispersed and mixed in the resin material that seals the LED chip, so that the LED chip emits substantially white light as a whole. The configuration of the LED 32 is not limited to the configuration described above. The LED 32 is a so-called top-surface emitting-type LED, in which a surface opposite to a surface mounted to the LED substrate 31 is a light emitting surface.

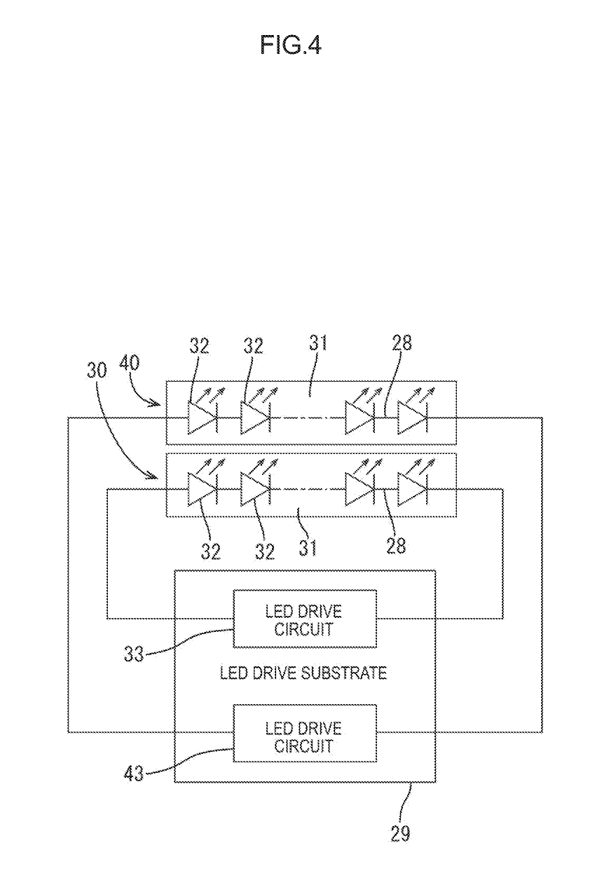

As shown in FIG. 2, the LED substrate 31 has a long and thin plate shape extending along a long side of the chassis 21 and is arranged in a posture in which a plate thickness direction perpendicular to a plate surface corresponds to the Y axis direction. As a material used for base material of the LED substrate 31, for example, a synthetic resin material (specifically, paper phenol, glass epoxy resin, or the like) can be used. A plurality of LEDs 32 are arranged on a mounting surface of the LED substrate 31 so that the LEDs 32 are aligned at predetermined arrangement intervals along a length direction (X axis direction) of the LED substrate 31. As shown in FIG. 4, a wiring pattern 28 composed of a metal film (copper film or the like) that serially connects the plurality of LEDs 32 is formed on the mounting surface of the LED substrate 31, and terminal portions formed at both ends of the wiring pattern 28 are connected to an external LED drive substrate 29, so that a driving power is supplied to each LED 32. The LEDs 32 are mounted on the LED substrate 31 by, for example, solder 34 (see FIG. 3).

As shown in FIG. 4, the LED drive substrate 29 (current supply unit) includes an LED drive circuit 33 that supplies current to the LED substrate 31 of the LED unit 30 and an LED drive circuit 43 that supplies current to the LED substrate 31 of the LED unit 40. The LED drive circuit 33 has a constant current circuit for constant-current driving the LEDs 32 of the LED unit 30 and the LED drive circuit 43 has a constant current circuit for constant-current driving the LEDs 32 of the LED unit 40. The current supplied from the LED drive circuit 43 to the LED substrate 31 of the LED unit 40 is lower than the current supplied from the LED drive circuit 33 to the LED substrate 31 of the LED unit 30. Therefore, power consumption of the LED unit 40 is smaller than power consumption of the LED unit 30. The LED drive substrate 29 is provided, for example, on a back surface of the bottom plate 23 of the chassis 21, but not limited to this.

The light guide plate 50 is composed of a nearly transparent (highly translucent) synthetic resin material (for example, acrylic resin such as PMMA, polycarbonate, or the like) whose refractive index is sufficiently higher than that of air. As shown in FIG. 2, the light guide plate 50 has a horizontally long square shape in plan view in the same manner as the liquid crystal panel 17 and the chassis 21. A long side direction and a short side direction of the light guide plate 50 correspond to the X axis direction and the Y axis direction, respectively, and a plate thickness direction perpendicular to a plate surface corresponds to the Z axis direction. As shown in FIG. 3, the light guide plate 50 has a pair of light incident surfaces 51 and 52 and a light emitting surface 53 which is a front side plate surface (one plate surface).

The light incident surface 51 is a surface facing the LED unit 30 (more specifically, light emitting surfaces 35 of the LEDs 32 included in the LED unit 30) of a pair of end surfaces on the long side and is a surface through which light emitted from the LEDs 32 of the LED unit 30 enters. The light incident surface 51 (first light incident surface) is a surface facing vertically downward. The plurality of LEDs 32 (unit light sources) included in the LED unit 30 are aligned at the same intervals along the light incident surface 51.

The light incident surface 52 is a surface facing the LED unit 40 (more specifically, light emitting surfaces 36 of the LEDs 32 included in the LED unit 40) of a pair of end surfaces on the long side and is a surface through which light emitted from the LEDs 32 of the LED unit 40 enters. The light incident surface 52 (second light incident surface) is a surface facing vertically upward. The plurality of LEDs 32 (unit light sources) included in the LED unit 40 are aligned at the same intervals along the light incident surface 52. The light guide plate 50 has a function to raise the light, which enters from the pair of light incident surfaces 51 and 52, toward the optical member 22 (toward the front side) while propagating the light inside the light guide plate 50, and emit the light from the light emitting surface 53.

As shown in FIG. 3, on a back side plate surface 54 of the light guide plate 50, a light reflecting sheet 55 that can reflect light, which is emitted from the plate surface 54 to the outside of the light guide plate 50, to the front side, is provided so as to cover the entire plate surface 54. The light reflecting sheet 55 is arranged so as to be sandwiched between the bottom plate 23 of the chassis 21 and the light guide plate 50. A lower end portion and an upper end portion of the light reflecting sheet 55 respectively face the light reflecting sheets 27 and 27 attached to the frame 26. Thereby, it is possible to cause the light emitted from each LED 32 of the LED units 30 and 40 to be repeatedly reflected between the light reflecting sheets 27 and 55 facing each other and efficiently enter the light incident surfaces 51 and 52.

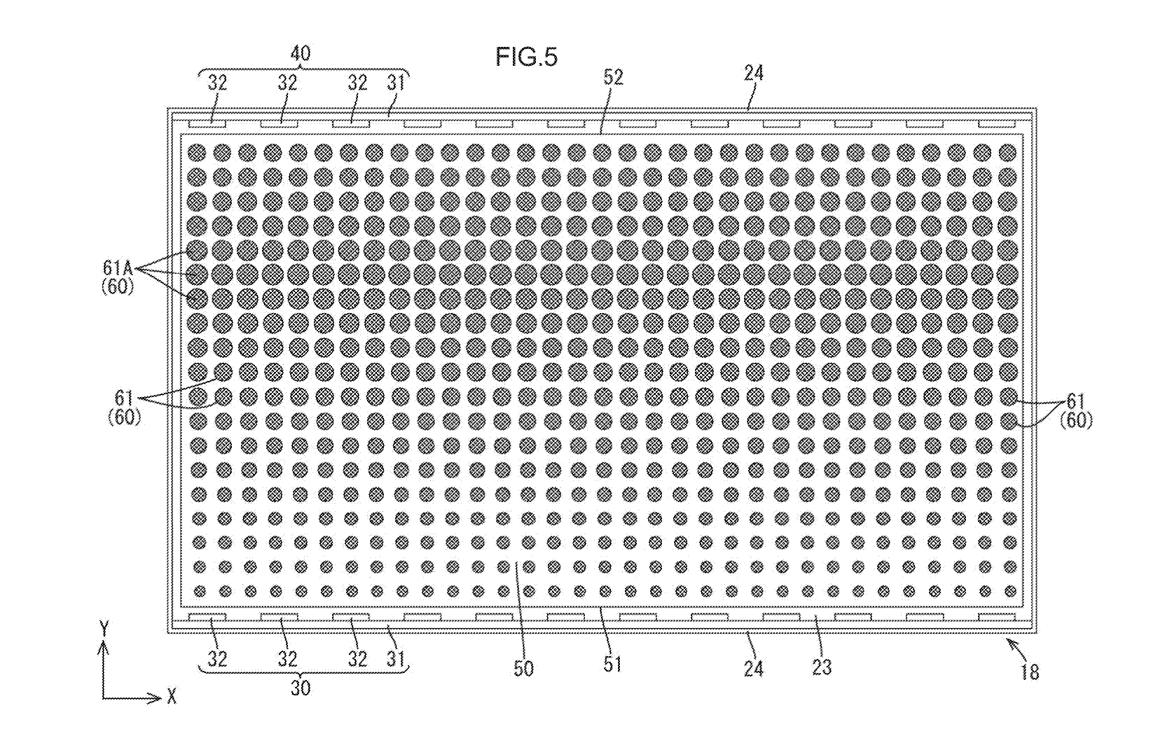

Further, a light-reflecting portion 60 (see FIG. 5) that promotes light emission from the light emitting surface 53 by reflecting the light entering into the light guide plate 50 to the light emitting surface 53 is formed on the plate surface 54 (the other plate surface) of the light guide plate 50. The light-reflecting portion 60 is composed of a plurality of dots 61 and is interposed between the plate surface 54 of the light guide plate 50 and the light reflecting sheet 55. The light-reflecting portion 60 is formed by printing a light reflective material on the plate surface 54 of the light guide plate 50. For the light-reflecting portion 60, ink (paste) which contains a metal oxide such as, for example, titanium oxide, and exhibits white is used as the light reflective material. The light-reflecting portion 60 can reflect light reaching the plate surface 54 among the light entering into the light guide plate 50 to the light emitting surface 53 while scattering the light. In the light scattered and reflected to the light emitting surface 53 by the light-reflecting portion 60, light whose incident angle to the light emitting surface 53 does not exceed a critical angle (light that is not totally reflected) is generated, so that the light can be emitted to the outside from the light emitting surface 53.

As described above, the current supplied to the LED substrate 31 of the LED unit 40 is lower than the current supplied to the LED substrate 31 of the LED unit 30, and the power consumption of the LED unit 40 is smaller than power consumption of the LED unit 30. Thereby, an amount of heat generation of the LED unit 40 can be smaller than an amount of heat generation of the LED unit 30. As a result, it is possible to suppress a situation in which the LED unit 40 becomes high temperature when air warmed by the heat generated from the LED unit 30 moves upward. However, an amount of light emission of the LED unit 40 to which a relatively low current is supplied is smaller than an amount of light emission of the LED unit 30. When there is a difference between the amount of light emission of the LED unit 40 and the amount of light emission of the LED unit 30, there is concern that unevenness occurs in the light emitted from the light emitting surface 53 of the light guide plate 50. Therefore, the light-reflecting portion 60 of the present embodiment has a configuration in which the unevenness of the light emitted from the light emitting surface 53, which is generated due to the difference between the amount of light emission of the LED unit 40 and the amount of light emission of the LED unit 30, can be reduced.

As shown in FIG. 5, the light-reflecting portion 60 is configured by distributively arranging a large number of dots 61 of the ink described above in the plate surface 54 of the light guide plate 50. The dot 61 has an approximately circular shape. The dots 61 are linearly arranged in parallel along the X axis direction and the Y axis direction with predetermined intervals within a surface of the plate surface 54. The area of each dot 61 and an arrangement interval between the dots 61 vary along the Y axis direction. The area of each dot 61 and the arrangement interval between the dots 61 are constant in the X axis direction.

The larger the area of the dot 61, the more the light can be emitted from the light emitting surface 53. The farther the dot 61 is arranged away from the LED units 30 and 40, the larger the area of the dot 61. The dot 61 having the largest area (the dot is denoted by reference symbol 61A) is arranged at a position nearer to the LED unit 40 than to the LED unit 30. Therefore, the farther the light-reflecting portion 60 is away from the LED units 30 and 40, the larger the area of the light-reflecting portion 60 per unit area (the area density of the light-reflecting portion 60) within the surface of the plate surface 54, and a position where the area of the light-reflecting portion 60 is the largest is eccentrically located close to the LED unit 40.

Next, effects of the present embodiment will be described. In the present embodiment, the power consumption of the LED unit 40 is smaller than the power consumption of the LED unit 30. Thereby, the amount of heat generation of the LED unit 40 can be smaller than the amount of heat generation of the LED unit 30. As a result, it is possible to suppress a situation in which the LED unit 40 becomes high temperature when air warmed by the heat generated from the LED unit 30 moves upward (toward the LED unit 40). Thereby, it is possible to suppress deterioration of light emission efficiency and product life of the LEDs 32 included in the LED unit 40, damage of the LED substrate 31 due to high temperature, and a situation where melting of the light guide plate 50 occurs. When the LED unit 40 becomes high temperature, there is concern that a crack occurs in the solder 34 due to thermal expansion of the solder 34. However, such a situation can also be suppressed.

Further, the light-reflecting portion 60 is included which promotes light emission from the light emitting surface 53 by reflecting the light entering into the light guide plate 50 to the light emitting surface 53 and in which regarding distribution of an area where the light-reflecting portion 60 exists per unit area within the surface of the plate surface 54, the farther the area is away from the LED unit 30 and the LED unit 40, the larger the area is, and a position where the area is the largest is eccentrically located close to the LED unit 40.

When the power consumption of the LED unit 40 is smaller than the power consumption of the LED unit 30, the amount of light emission of the LED unit 40 is smaller than the amount of light emission of the LED unit 30, so that there is concern that luminance unevenness occurs in the light emitted from the light emitting surface 53 of the light guide plate 50. Therefore, in the above configuration, the light-reflecting portion 60 is included which reflects the light entering into the light guide plate 50 to the light emitting surface 53, and for the light-reflecting portion 60, regarding distribution of an area where the light-reflecting portion 60 exists per unit area within the plate surface 54 of the light guide plate 50, a position where the area is the largest is eccentrically located close to the LED unit 40. By doing so, it is possible to promote emission of light from a position close to the LED unit 40 in the light emitting surface 53. As a result, when the amount of light emission of the LED unit 40 is smaller than the amount of light emission of the LED unit 30, it is possible to suppress a situation in which luminance at a position close to the LED unit 40 on the light emitting surface 53 is lower than luminance at a position close to the LED unit 30, so that it is possible to suppress the luminance unevenness.

Further, the LED drive substrate 29 is included which supplies current to the LED unit 30 and the LED unit 40 and supplies current, which is lower than current supplied to the LED unit 30, to the LED unit 40. By supplying low current to the LED unit 40, it is possible to reduce the power consumption of the LED unit 40.

The LED unit 30 includes a plurality of LEDs 32 aligned at the same intervals along the light incident surface 51, and the LED unit 40 includes a plurality of LEDs 32 aligned at the same intervals along the light incident surface 52. The number of LEDs 32 included in the LED unit 30 and the number of LEDs 32 included in the LED unit 40 are the same, and gaps between the plurality of LEDs 32 included in the LED unit 30 and gaps between the plurality of LEDs 32 included in the LED unit 40 are the same. By doing so, the LED unit 30 and the LED unit 40 can be the same members, so that it is possible to reduce cost related to manufacturing.

### Second Embodiment

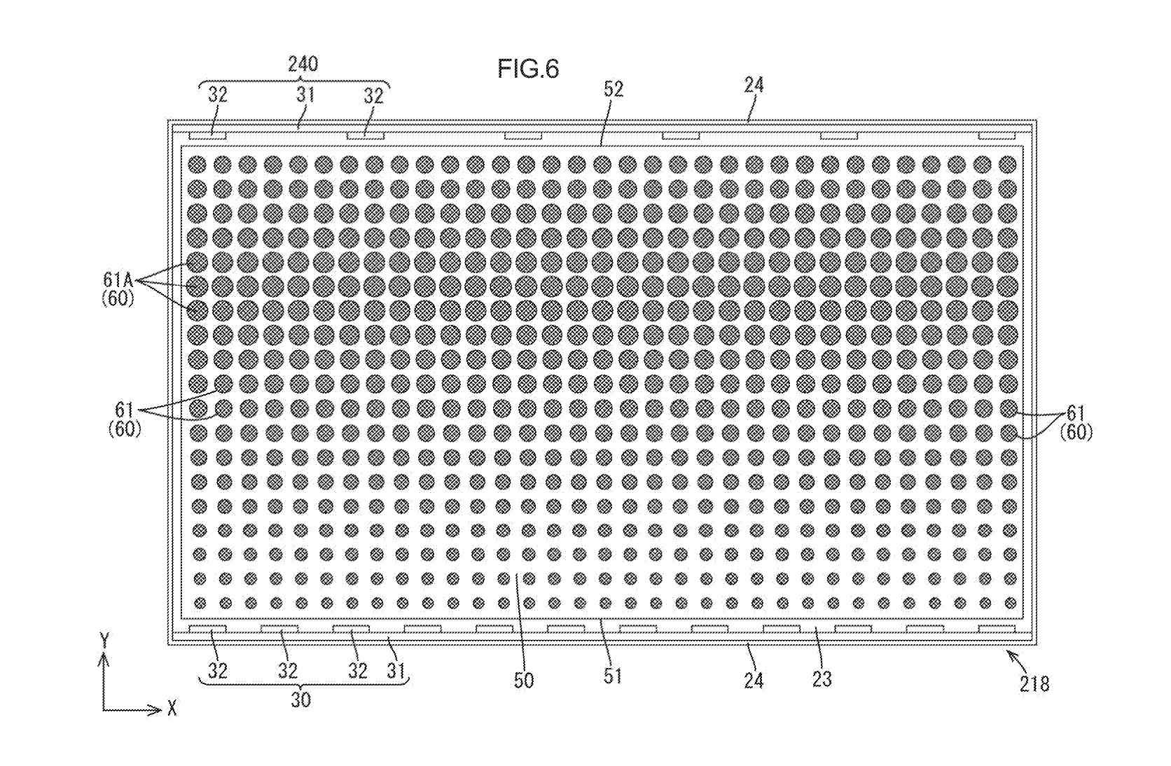

Next, a second embodiment of the present embodiment will be described with reference to FIG. 6. The same components as those of the above embodiment are denoted by the same reference numerals, and redundant descriptions are omitted. In a backlight device 218 of the present embodiment, as shown in FIG. 6, the number of LEDs 32 included in an upper LED unit 240 is smaller than the number of LEDs 32 included in a lower LED unit 30. Thereby, the number of LEDs 32 included in the LED unit 240 is reduced, so that the power consumption of the LED unit 240 can be smaller than the power consumption of the LED unit 30.

### OTHER EMBODIMENTS

The present disclosure is not limited to the embodiments explained by the above description and the drawings, and for example, the following embodiments are included in a technical scope of the present disclosure.

(1) While the liquid crystal display device using a liquid crystal panel as a display panel is illustrated in the embodiments described above, the present disclosure can be applied to a display device using other types of display panel.
(2) While an LED is used as a light source in the embodiments described above, an organic EL or the like can also be used as a light source.
(3) In the embodiments described above, a configuration in which the LED unit 30 and the LED unit 40 has the same type of LEDs 32 is illustrated. However, the configuration is not limited to this. For example, the LEDs included in the LED unit 40 and the LEDs included in the LED unit 30 may be different from each other. For example, the power consumption of the LED unit 40 may be made smaller than the power consumption of the LED unit 30 by reducing the number of LED chips (LED elements) of an LED included in the LED unit 40 to less than the number of LED chips of an LED included in the LED unit 30.
(4) The light incident surface of the light guide plate 50 may be other than an end surface of the light guide plate 50. For example, in the light guide plate 50, a circumferential end portion of a plate surface opposite to the light emitting surface may be the light incident surface.
(5) The dot pattern that forms the light-reflecting portion of the light guide plate is not limited to the dot pattern illustrated in FIG. 5, but may be appropriately changed.

The present disclosure contains subject matter related to that disclosed in Japanese Priority Patent Application JP 2018-030607 filed in the Japan Patent Office on Feb. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An illumination device comprising:
a first light source;
a second light source which is arranged vertically above the first light source and whose power consumption is smaller than power consumption of the first light source; and
a light guide plate having a first light incident surface which is composed of a surface facing the first light source and through which light emitted from the first light source enters, a second light incident surface which is composed of a surface facing the second light source and through which light emitted from the second light source enters, and a light emitting surface which is composed of one plate surface and from which light incident from the first light incident surface and the second light incident surface is emitted.

2. The illumination device according to claim 1, further comprising:
a light-reflecting portion which is arranged on the other plate surface of the light guide plate and promotes light emission from the light emitting surface by reflecting light entering into the light guide plate to the light emitting surface and in which regarding distribution of an area where the light-reflecting portion exists per unit area within a surface of the other plate surface, the farther the area is away from the first light source and the second light source, the larger the area is, and a position where the area is the largest is eccentrically located close to the second light source.

3. The illumination device according to claim 1, further comprising:
a current supply unit which supplies current to the first light source and the second light source and supplies current, which is lower than current supplied to the first light source, to the second light source.

4. The illumination device according to claim 3, wherein
the first light source includes a plurality of unit light sources aligned at the same intervals along the first light incident surface, and the LED unit 40 includes a plurality of LEDs 32 aligned at the same intervals along the light incident surface 52,
the second light source includes a plurality of unit light sources aligned at the same intervals along the second light incident surface,
the number of the unit light sources included in the first light source and the number of the unit light sources included in the second light source are the same, and
gaps between the plurality of unit light sources included in the first light source and gaps between the plurality of unit light sources included in the second light source are the same.

5. The illumination device according to claim 1, wherein
the first light source includes a plurality of unit light sources aligned along the first light incident surface,
the second light source includes a plurality of unit light sources aligned along the second light incident surface, and
the number of the unit light sources included in the second light source is smaller than the number of the unit light sources included in the first light source.

6. A display device comprising:
the illumination device according to claim 1; and
a display panel that displays an image by using light emitted from the illumination device.
